(19) United States
(12) Patent Application Publication
(10) Pub. No.: US 2017/0262585 A1
(43) Pub. Date: Sep. 14, 2017

(54) SYSTEMS, DEVICES, AND METHODS FOR COMMUNICATING PATIENT MEDICAL DATA

(71) Applicant: Medicos, Inc., Layton, UT (US)

(72) Inventors: Mike Grow, Layton, UT (US); Michael Dee, Layton, UT (US)

(73) Assignee: Medicos, Inc., Layton, UT (US)

(21) Appl. No.: 15/066,405

(22) Filed: Mar. 10, 2016

(51) Int. Cl. G06F 19/00; H04W 12/06; H04L 29/06

(52) U.S. Cl. CPC G06F 19/322; H04L 63/08; H04W 12/06

(57) ABSTRACT

A mobile computing device includes an authentication component, a destination component, a permission component, and a message component. The authentication component is configured to authenticate a user with an authentication server by providing authentication information to the authentication server. The destination component is configured to identify a health care provider available to provide health care for the user and to receive medical data. The permission component is configured to, in response to authenticating the user, receive input from a user indicating authorization to send medical data for the first patient to the health care provider. The message component is configured to send a message providing permission to a remote server to send medical data for the user stored in remote storage to the health care provider.

### TECHNICAL FIELD

The disclosure relates generally to methods, systems, and devices for communicating patient medical data.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 is a schematic block diagram illustrating an implementation of a system for communicating medical data;

FIG. 2 is a schematic block diagram illustrating example components of a medical data system, according to one implementation;

FIG. 3 is a schematic block diagram illustrating example components of a client, according to one implementation;

FIG. 4 is a schematic signal diagram illustrating a method for communicating medical data, according to one implementation;

FIG. 5 is a schematic flow chart diagram illustrating a method for authorizing communicating of medical data, according to one implementation;

FIG. 6 is a schematic flow chart diagram illustrating a method for communicating medical data, according to one implementation; and

FIGS. 7-14 illustrate example screenshots of one implementation of an interface for authorizing and communicating medical data, according to one implementation.

### DETAILED DESCRIPTION

Visits to medical providers often present challenges to patients and their families. These challenges include fears and worries about medical conditions as well as about being subjected to tests, observation, and/or medical conditions. Additionally, patients and their families must also track records about medical conditions, fill out paperwork, see to payment, and/or a large number of other procedural or administrative tasks.

The administrative tasks can be especially burdensome with serious medical conditions or chronic illnesses when patients must visit different doctors, specialists, or have many procedures performed. For example, patients visiting a new health care provider or new doctor's office must fill out personal medical information about the patient's physical condition, medical history, allergies, and/or a wide array of other information. Filling out and refilling out this information can be burdensome or difficult to a patient, a patient's parent or guardian or caretaker, or other person assisting a patient while the patient goes from office to office or specialist to specialist.

In some situations, medical data may not even be known by a patient. For example, children and teens may not be aware of the answers to many questions. Thus, a parent or guardian may need to always attend visits to medical providers with the child or teen. Requiring a parent or guardian to be present with a child may be problematic in the case an emergency arrives or a parent is away from the child. In these situations, calls to a parent may be required to obtain the required information. Additionally, repeatedly filling out forms may result in errors, inaccuracies, or omissions in the medical data even if a parent is present. These errors may occur when the patient, parent or other person fills out a form, but may also be occur when an employee enters the data from the form into a computer system.

Filling out forms in advance of an appointment also extends the length of an appointment. For example, a patient must arrive, receive the appropriate forms from a receptionist, fill out the forms, and provide the forms back to the receptionist for review and/or entry. Because the data is provided upon arrival, a doctor or other medical provider may be required to review the data in order to determine how to proceed with treating or testing a patient, further extending the length of the appointment. The increased appointment length can limit the number of patients a medical provider can treat or assist and can be an inconvenience for patients.

The present disclosure presents systems and methods for communicating medical data. In one embodiment, medical data is stored on a server or at a location remote from a user and the user is able to authorize sending of the data to a medical provider. According to one embodiment, a system or server includes a patient data component, a provider component, a session component, an authorization component, and a communication component. The patient data component is configured to store patient medical data corresponding to one or more patients, including medical data for a first patient. The provider component is configured to store destination information corresponding to a plurality of health care providers that can receive the patient medical data from the system. The session component is configured to establish and validate communication with the first patient via a remote device. The authorization component is configured to receive, from the remote device, a message indicating authorization from the first patient to send the medical data for the first patient to a first health care provider of the plurality of health care providers. The communication component is configured to send, in response to the authorization, the medical data for the first patient to the destination information corresponding to the first health care provider.

In one embodiment, a mobile computing device includes an authentication component, a destination component, a permission component, and a message component. The authentication component is configured to authenticate a user with an authentication server by providing authentication information to the authentication server. The destination component is configured to identify a health care provider available to provide health care for the user and to receive medical data. The permission component is configured to, in response to authenticating the user, receive input from a user indicating authorization to send medical data for the first patient to the health care provider. The message component is configured to send a message providing permission to a remote server to send medical data for the user stored in remote storage to the health care provider.

In one embodiment, a mobile computing device may include a computer or mobile device (such as a smartphone, tablet, laptop, or the like). For example, the mobile device may include a smartphone with an application (such as an application from an app store) implementing the above components on the mobile device. The user may create an account and enter demographic information, history & physical (H&P) data, insurance information, or other data onto the mobile device. The entered data may then be communicated to a server or system in an encrypted manner, which stores the data in an encrypted database. In one embodiment, the mobile device may delete any of the entered data from the mobile device so that all the information is stored securely at a remote location and not locally on the device. The server or system may store a connection information for physicians that are available or subscribed to receive data from the server or system. The connection information may be stored in a provider registry. The user may be able to search or browse the provider registry and select a subscribing physician using the mobile device and request that the medical data for the user be sent to the selected physician. In one embodiment, a user may be able to send medical data on behalf of the user or a different individual for whom the user is authorized, such as a child or other dependent. The server or system, in response to receiving the request from an authorized user or device, securely sends the required data to a medical practice management software (PMS) system or an electronic medical records (EMR) system for the selected physician. In one embodiment, the server or system sends the required data in advance of a scheduled appointment.

Embodiments and implementations disclosed herein may provide significant benefits and advantages to patients and medical providers. For example, the medical data may be communicated in advance of an appointment. Communicating in advance may allow patients or those present with patients to not fill out forms every time they visit a new physician or health care provider. Additionally, electronic communication may significantly reduce the number of errors made by those filling out form and/or those entering data into a computer system. Furthermore, because medical information or medical records may be sent directly from the patient or the authorized representative of the patient electronically, there is a reduction in paperwork and human resources needed for receiving and processing the medical information thereby increasing the efficiency and reducing the overhead costs of the medical office. Furthermore, because a medical record may be used over and over, the medical records may become more accurate over time due to being reviewed and reused repeatedly so that errors are caught and corrected. Security may also be increased because private information is not visually presented or viewable in waiting rooms or on pieces of paper that have not been correctly managed or shredded. Furthermore, parents may not need to disclose private information via a telephone when they are not present with a child.

Remote storage of the medical data may reduce the likelihood that a stolen or lost device results in exposure of medical data to others. Additionally, the remote storage allows for accessibility from any location and the ability to securely and easily communicate information to a physician without the need to carry paper copies or records.

In one embodiment, authorization by a user for the sending of medical records may significantly simplify determinations by a physician of what records should be reviewed by the physician. Because medical data can include very private and sensitive details about individuals and their medical conditions, many laws and regulations, such as the Health Insurance Portability and Accountability Act (HIPAA) in the United States of America, may be in place to control when a health care provider can access or review medical data. By having a patient explicitly authorize the sending of medical data to the health care provider, the health care provider's risks of inadvertently accessing data at incorrect times can be significantly reduced. Furthermore, the user is able to control when the data is sent to a provider and knows that the data communicated to a health care provider is accurate.

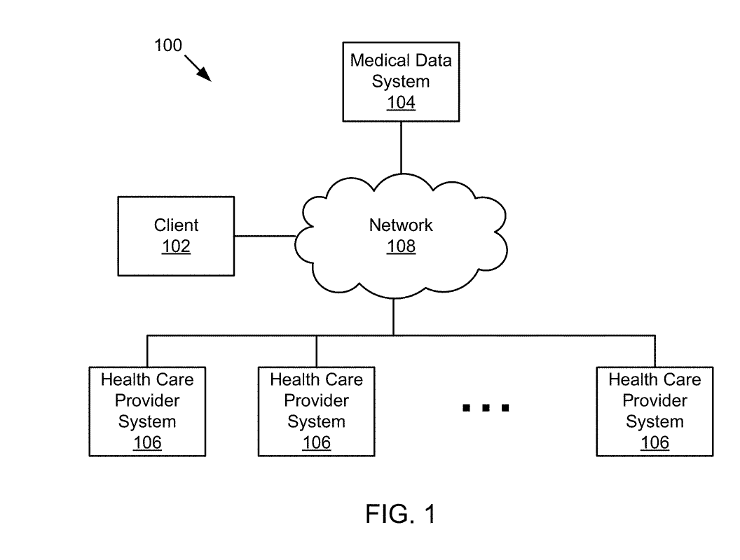

Referring now to the figures, FIG. 1 illustrates a system 100 for communicating medical data. The system 100 includes a client 102, a medical data system 104, and a plurality of health care provider systems 106 that may communicate over a network 108. The client 102 may include a computing device controlled by a user or patient. The client 102 may include any type of computing device such as a smartphone, tablet, desktop computer, or the like. The client 102 may also include an application or code executing on a computing device or within a browser or other application of the computing device. Although only one client 102 is shown, a plurality of different clients for the same or different users may also be present and/or connected to the network 108. The medical data system 104 may store medical data for one or more patients and communicate the data, when requested or approved by a user on the client 102, to one or more health care provider systems 106. The health care provider systems 106 may include a PMS or EMR for one or more different health care providers, medical practices, or the like. The network 108 may include one or more networks, such as a local area network (LAN), wide area network (WAN), the Internet, or the like.

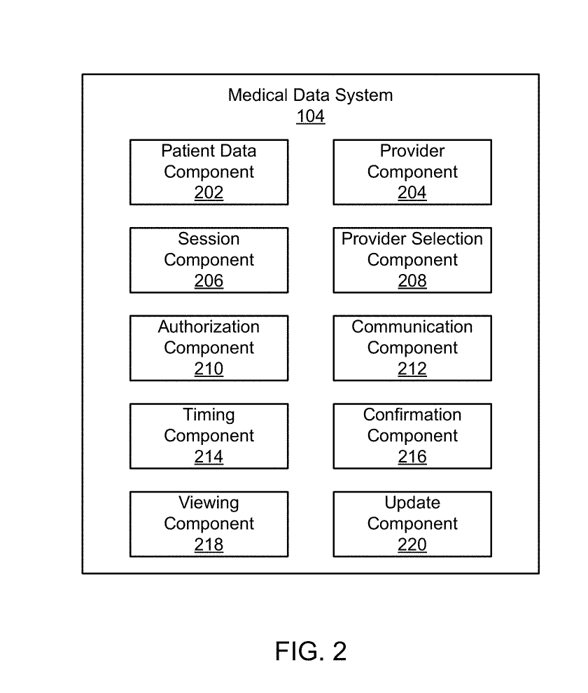

FIG. 2 is schematic a block diagram illustrating example components of a medical data system 104. In the depicted embodiment, the medical data system 104 includes a patient data component 202, a provider component 204, a session component 206, a provider selection component 208, an authorization component 210, a communication component 212, a timing component 214, a confirmation component 216, a viewing component 218, and an update component 220. The components 202-220 are given by way of illustration only and may not all be included in all embodiments. In fact, some embodiments may include only one or any combination of two or more of the components 202-220. Some of the components 202-220 may be located outside the medical data component 104.

The patient data component 202 is configured to store patient medical data corresponding to one or more patients. The patient medical data may include information that relates to health care, such as information about a medical condition, medical history, insurance information, and/or the like. In one embodiment, the patient medical data stored by the patient data component 202 includes information that is generally requested upon admitting a patient or accepting a new patient by a medical facility or office. In one embodiment, the patient data component 202 stores data that is generally included on forms for admitting a patient or for providing health care for patients. In one embodiment, the patient data component 202 stores and manages data that includes demographic information about a patient, medical history including previous medical procedures, current medical condition, allergies, insurance information, or any other medical data.

In one embodiment, the patient data component 202 is configured to store medical data in a secure manner. For example, data stored by the patient data component 202 may be encrypted. In one embodiment, data for different users are encrypted using different keys so that medical data for each patient are independently encrypted and managed. The patient data component 202 may be configured to receive data in an encrypted form, decrypt the data to determine where or how the data should be stored, re-encrypt the data, and store the data in encrypted form.

In one embodiment, the patient data component 202 is configured to update or modify a database for a specific patient. In one embodiment, the patient data component 202 receives one or more messages from a client device indicating additions or edits of the medical data for the patient and the ability to add or edit the medical data for the first patient based on the one or more messages. For example, the patient data component 202 may add, remove, or modify stored medical data based on messages received from one or more client devices used by a validated patient.

The provider component 204 is configured to store destination information corresponding to a plurality of health care providers that can receive the patient medical data from the medical data system 104. For example, there may only be a limited number of health care providers that have systems that are able to receive data from the medical data system 104 or that are subscribed to receive data from the system 104. The provider component 204 may store the destination or connection information, as well as any other identifying information, for any and all health care providers that are able to receive medical data from the medical data system 104. In one embodiment, the provider component 204 may store a name, address, medical practice type, available medical services, and connection information for a health care provider.

The session component 206 is configured to establish a communication session with a remote device, such as the client 102 of FIG. 1. For example, the session component 206 may establish a secure communication session where communication between the remote device and the medical data system 104 is secured and/or encrypted. In one embodiment, the session component 206 may validate or authenticate that a person operating the client 102 is a specific person or patient and is therefore authorized to provide input and or control how stored patient data is sent or modified. Secure methods of authentication include validating login credentials, two-factor identification such as confirmation via email, validation that a device is registered as owned by a user, providing of a certificate, or by any other authentication method.

The provider selection component 208 is configured to determine a selected health care provider from a plurality of health care providers that can receive the patient medical data from the medical data system 104. In one embodiment, the provider selection component 208 may receive a selection from the user on a remote device, such as a client browser, client smartphone, or other client computing device. For example, the provider selection component 208 may receive a provider query from the remote device. The provider query may include one or more search or query details such as a name, location, practice type, specialty, available procedures or services, or the like of a health care provider. The provider selection component 208 may then identify one or more results for the provider query comprising information for one or more health care providers of the plurality of health care providers. For example, the provider selection component 208 may identify one or more providers that match the query and which are available to receive patient data from the medical data system. The provider selection component 208 may determine one or more details to show in a search result and return the one or more results to the remote device for viewing by a user. The user may then be able to select one of the results as a health care provider with whom the user has or will schedule a medical appointment or procedure. The remote device may send an indication to the medical data system 104 of which health care provider has been selected. The provider selection component 208 may then determine destination or connection information for the selected health care provider. For example, the provider selection component 208 may identify a website, web domain, Internet protocol (IP) address, email address, account number, or any other connection or destination information where the medical data system 104 can send medical data for receipt by the selected patient. The destination or connection information may be retrieved from a provider registry stored or managed by the provider component 204.

The authorization component 210 is configured to receive, from the remote device, a message indicating authorization from a user to send medical data for the user (or for another patient for whom the user is authorized) to a selected health care provider. The authorization component 210 may receive the message during a validated/authenticated session with a user. In one embodiment, authorization or permission must be received from the user or patient (or a guardian) each time the user's or patient's medical data is communicated from the medical data system 104 to another party or health care provider.

The authentication/validation may be secure enough for the medical data system 104 to trust that the user is actually the user or an authorized person to control the medical records of the user. The message may indicate the provider for whom sending of the medical records is authorized. The message may reflect actual permission or a request from the user to send data. Obtaining or receiving actual permission from an authenticated user may significantly reduce complexity for health care providers in providing health care services for the user. For example, because the data has been explicitly authorized to be sent to the health care provider, the health care provider has a reduced concern that the health care provider may not be authorized to view/review the received medical data. Rather, a doctor or other provider can review the data with reduced concern since the data has been sent in response to an explicit request or authorization by the patient or guardian of the patient.

The communication component 212 is configured to send medical data to a selected or destination health care provider. For example, the communication component 212 may send encrypted medical data corresponding to a patient that has authorized or requested the sending of the data. In one embodiment, the communication component 212 may only send the data in response to authorization, such as receiving a message indicating authorization or permission to send the data to the specific health care provider. The communication component 212 may send the data using connection or destination information stored by the provider component 204 for the selected health care provider. In one embodiment, the communication component 212 may send the medical data in a format and manner HIPAA and/or with other applicable laws.

The timing component 214 is configured to determine a timing for the communication component 212 to send the medical records to a selected health care provider. In one embodiment, the timing component 214 may identify a scheduled time for a medical event with the selected health care provider. The medical event may include an appointment with the health care provider for testing, examination, interviewing, performing a procedure, or any other health care service or procedure. The scheduled time may include a date and time of day for when the medical event is scheduled. The timing component 214 may determine a time in advance of the medical event for when the medical data should be send to the health care provider. For example, the timing component 214 may default to sending the data 24 hours, one business day, 2 or more hours, or any other time period before the scheduled time of the event. In one embodiment, the timing component 214 may only send the medical data within a week, one business day, or other time period of the medical event in order to reduce the chance that the medical data is communicated to a health care provider before a patient has an opportunity for canceling the appointment. For example, it may be desirable to only communicate the medical data when it becomes unlikely that the patient or user will cancel the appointment so that the patient's medical data is not communicated to health care providers that do not actually provide health care services to the patient. The timing component 214 may then trigger sending of the medical data by the communication component 212 in compliance with the timing determined by the timing component 214.

The confirmation component 216 is configured to confirm that the medical data has been received and/or acknowledge by the correct health care provider. For example, in response to sending the medical data for the first patient to the destination, the confirmation component 216 may receive confirmation from the health care provider that the data for the first medical patient has been received. The confirmation component 216 may receive an acknowledgement message that the data has been received and verified by an EMR or PMS of the selected health care provider. In one embodiment, the confirmation component 216 may send a message to the remote device that indicates that the medical data has been sent and received by a selected health care provider.

The viewing component 218 is configured to provide medical data to a client device, such as the client 102 of FIG. 1. In one embodiment, the viewing component 218 only sends the medical data to the client device if a user of the client device has been validated or authorized. The medical data may only include medical data corresponding to the current user of the client or to patients for whom the user is a parent or legal guardian. The viewing component 218 may provide the medical data to the remote device to allow a user or patient to review the accuracy of the data, add information to the medical data, or otherwise modify the data. For example, a user may be able to edit the data and upload the changes for storage by the patient data component 202.

The update component 220 is configured to prompt a user to review or update medical data for a user or patient. For example, the update component 220 may periodically (e.g., on a weekly, monthly, or yearly basis) send a message to a client device to prompt a user to update their medical data. As another example, the update component 220 may prompt a user for updates each time a medical event takes place for the patient. For example, the update component 220 may prompt a user to update or review data after a scheduled time for a medical event has passed. For example, a user may indicate a scheduled time for a medical event and trigger sending of medical data to a corresponding health care provider. A short time after the medical event, the medical data system 104 may request or remind the user to update data stored remotely by the patient data component 202.

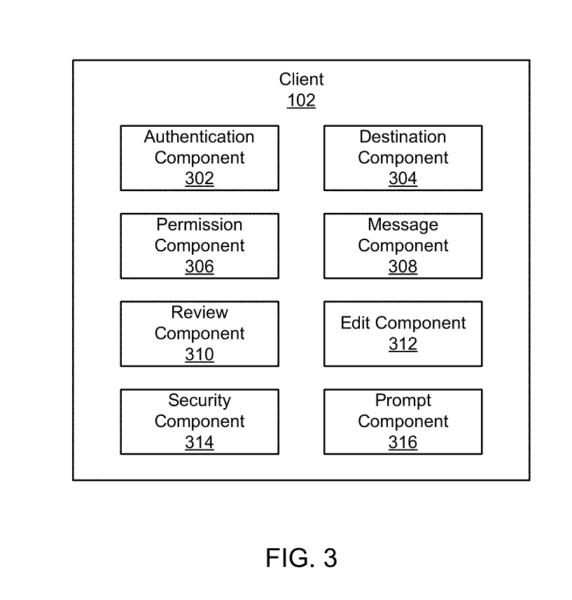

FIG. 3 is schematic a block diagram illustrating example components of a client 102. In the depicted embodiment, the client 102 includes an authentication component 302, a destination component 304, a permission component 306, a message component 308, a review component 310, an edit component 312, a security component 314, and a prompt component 316. The components 302-316 are given by way of illustration only and may not all be included in all embodiments. In fact, some embodiments may include only one or any combination of two or more of the components 302-316. Some of the components 302-316 may be located outside the client 102.

The authentication component 302 is configured to authenticate a user of the client 102 with a remote system, such as the medical data system 104 of FIG. 1 or 2. The authentication component 302 may authenticate the user by prompting the user for authentication details and forwarding the authentication details to an authentication server. For example, the authentication component 302 may receive a login name and password from the user and forward those details to the remote server for verification. It should be understood that any type of authentication may be used, including two-factor (or more) authentication methods. Upon verification of the details, the authentication component 302 may receive an indication that the user has been authenticated and allow the user to proceed to additional interfaces or functionality of the client 102.

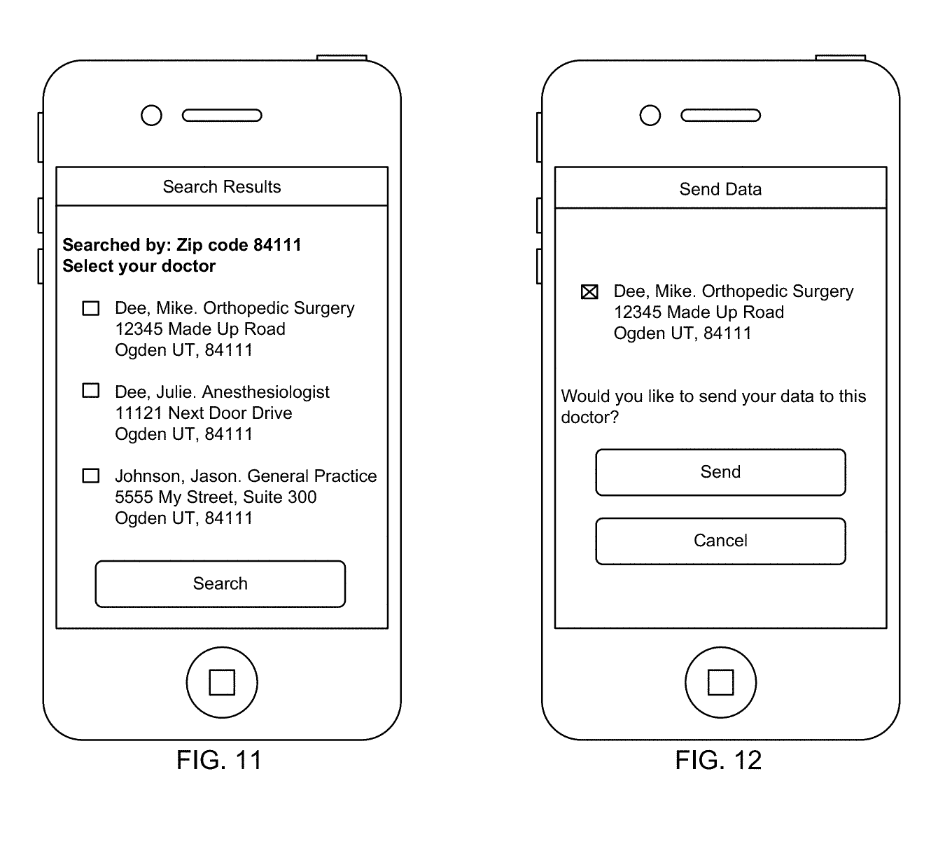

The destination component 304 is configured to identify a health care provider available to provide health care for the user/patient and to receive medical data. For example, the destination component 304 may present information about one or more health care providers and allow the user to select one of the health care providers as a destination for remotely stored medical data. In one embodiment, the destination component 304 receives a provider query from a user. The provider query may include one or more details about a health care provider such as name, practice area, or any other details about a health care provider or health care practice (e.g., see FIG. 10). The destination component 304 provides the provider query to a remote server and receives search results (e.g., see FIG. 11) indicating one or more providers that are configured to receive the medical data for the user from the remote storage. The user may select one of the results as a destination health provider for the user's medical data. For example, the user may select a health provider with whom the user has a scheduled appointment so that the medical data can be sent to the health provider. In one embodiment, upon selection of the health care provider, the user may provide information about a scheduled appointment with the health care provider. For example, the information may include a schedule time, a type of health care service scheduled, or any other details about health care services to be received from the health care provider. These details may be sent to the remote server, such as the medical data system 100 of FIG. 1 or 2.

The permission component 306 is configured to receive input from a user to authorize sending of medical data to a selected health care provider. For example, the permission component 306 may provide an interface for a user to indicate permission or authorization for the user to send data to the health care provider (e.g., see FIG. 12). The user may select a button or option to approve sending of the data and thereby indicate authorization to send the medical data to the health care provider.

The message component 308 sends a message providing permission to send the remotely stored data to the selected health care provider. For example, the message component may send a message providing permission to a remote server to send medical data for the user stored in remote storage to the health care provider. The message may include an indication of permission, identifying information for a user or patient, and/or identifying information for a health care provider to whom the medical data should be sent. In one embodiment, the message provides permission to the remote server to provide the medical data for the user in advance of a scheduled appointment with the health care provider. For example, the medical data may not be sent at the time of receipt of the message, but may occur at a later time in accordance with a timing of a scheduled event (e.g., see FIG. 14).

The review component 310 is configured to provide medical data for viewing or editing by a user on the client 102 (e.g., see FIG. 8). In one embodiment, the review component 310 receives medical data for the user from remote storage and presents the medical data for the user on a display for viewing by the user. The review component 310 may receive the medical data in an encrypted state, decrypt the medical data, and present the decrypted medical data on a display screen of the client 102 for viewing by a user. Thus, the user may be able to review and see the data that is stored in remote storage.

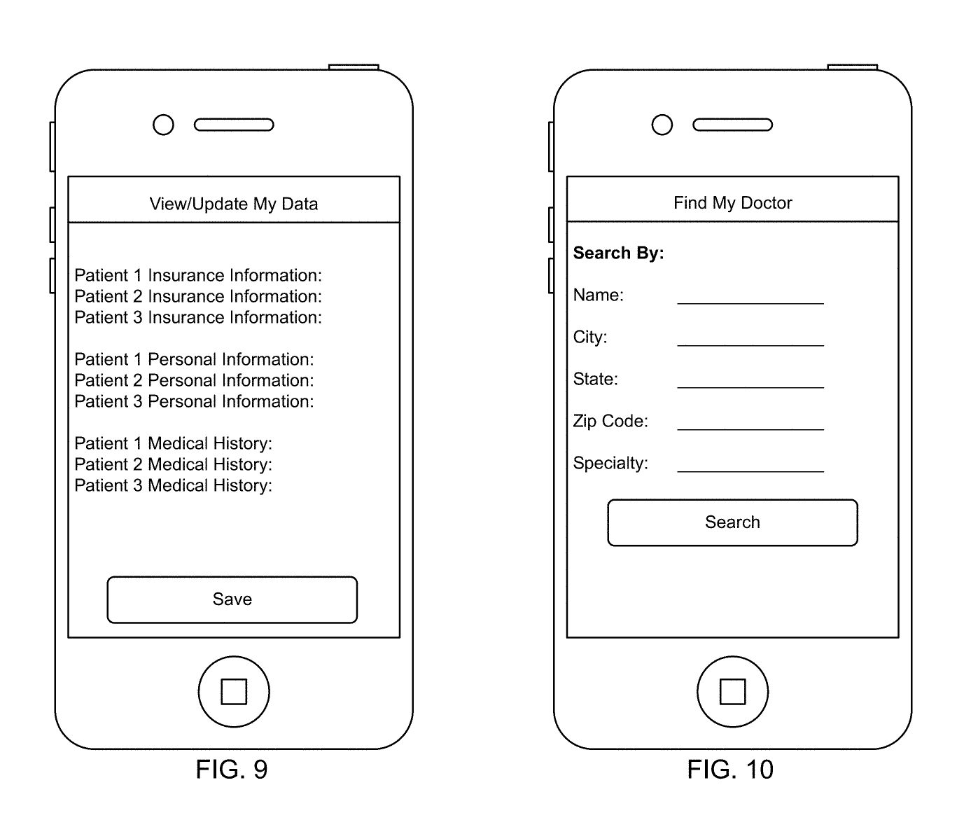

The edit component 312 allows a user to edit medical data. For example, during review of medical data presented by the review component 310, the edit component 312 may receive input from the user indicating modifications to the medical data for the user (e.g., see FIG. 9). The user may select information and provide modified information, add information, or delete information from the medical records. When the user has finished making modifications, the user may select an option provided on an interface to submit the changes to a remote server, such as the medical data system 104 of FIG. 1 or 2. The changes may be implemented by the remote server to update the remotely stored data.

The security component 314 is configured to secure data stored and/or sent by the client 102. In one embodiment, the security component 314 stores data in an encrypted manner on the client 102 and only decrypts the data when in random access memory (RAM) or other memory that is erased when power is lost (e.g., non-persistent memory). In one embodiment, the security component 314 encrypts data, such as new medical data or edits provided by a user, before it is sent to a remote server for storage. In one embodiment, the security component 314 deletes any medical data for the user from any local memory in response to disconnecting from the authentication server. For example, medical data may only be stored or accessed on the client 102 when a secure session with the medical data system 104 is active. At all other times the medical data may be wiped or deleted from the client 102 so that any subsequent party that obtains the client 102, through theft, loss or otherwise, will not have access to the medical data.

The prompt component 316 is configured to prompt a user to update or review medical data stored in the remote storage. For example, the prompt component 316 may periodically (e.g., on weekly, monthly, annually, semi-annually, or other periodic basis) provide a prompt to a user to login and update their medical data. In one embodiment, the prompt component 316 may prompt a user to update the medical data each time they have a known medical appointment. For example, each time medical data is sent to a health care provider, the prompt component 316 may wait a period of time and prompt a user to enter updated medical data to capture any changes or modifications in response to the appointment.

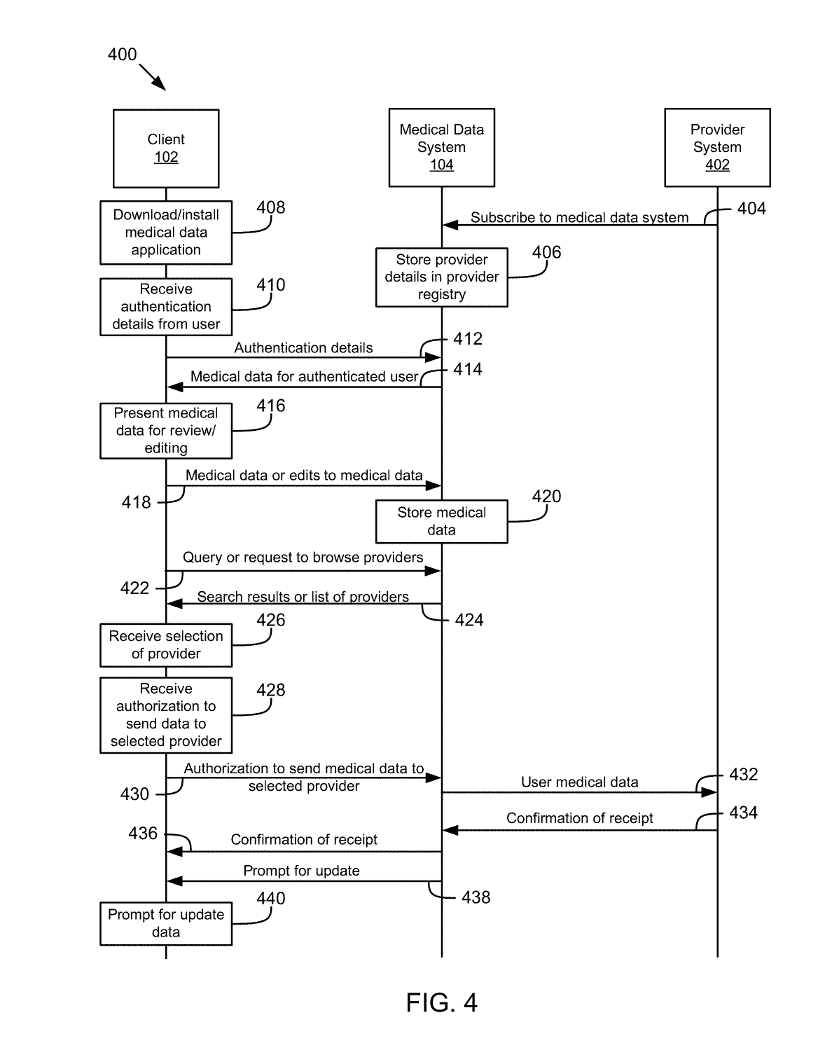

FIG. 4 is a signal diagram illustrating a method 400 for communicating medical data. The method 400 illustrates communication between a client 102, a medical data system 104, and a provider system 402 (which may include, for example, an EMR or PMS). The order of the functions, messages, and calculations of method 400 are illustrative only and may be rearranged depending on a current state of medical data or other usage variations. For example, the messaging and processing indicated in FIG. 4 may be rearranged without limitation unless explicitly indicated otherwise.

The provider system 402 subscribes 404 to the medical data system 104. For example, the provider system 402 may subscribe 404 by sending information confirming or indicating that the provider system 402 is configured to receive medical data form the medical data system 104. The medical data system 104 stores 406 the provider details, including name, address, practice type, or any other details regarding a health care provider in a provider registry.

The client 102 downloads or installs 408 (or otherwise obtains) a medical data application for interfacing with the medical data system 104. The client 102 receives 410 authentication details from a user. For example, the authentication details may include a username and/or password. The client 102 provides the authentication details 412 to the medical data system 104, which authorizes the user.

In response to authorization, the medical data system 104 sends 414 medical data for the authenticated user to the client 102. The client 102 presents 416 the medical data for review or editing by the user. If any medical data or edits are entered by the user, the client 102 provides 418 the medical data or edits to the medical data to the medical data system 104. The medical data system 104 stores 420 the medical data for the user at a location remote from the client 102.

The client 102 provides 422 a query or request to browse or search the provider registry. The medical data system 104 provides 424 search results or list of providers for viewing by a user. The client 102 present the results or list to the user and receives 426 a selection of a provider from a user. The client 102 may provide additional details for the selected provider.

If the user wishes to send medical data to the provider, for example because an appointment has or will be scheduled with the provider, the client 102 receives 428 authorization from the user to send data to the selected provider. In response to receiving 428 authorization, the client 102 sends 430 a message authorizing the medical data system 104 to send medical data to the selected provider. The message may identify a patient (such as the user or a patient for whom the user is a guardian or otherwise authorized by law to oversee medical records), a selected health care provider, and/or a time for a scheduled appointment or procedure. The medical data system 104 generates an encrypted message including the user's medical data and sends 432 the user's medical data to the provider system 402. The provider system 402 confirms 434 receipt of the medical data and the medical data system 104 confirms 436 receipt with the client 102.

In one embodiment, the medical data system 104 may prompt 438 the client 102 for updated medical data. The client 102 prompts 440 the user for updated medical data. In one embodiment, prompting 438/440 the user or client 102 for medical data may occur periodically or in response to determining that a medical appointment has occurred.

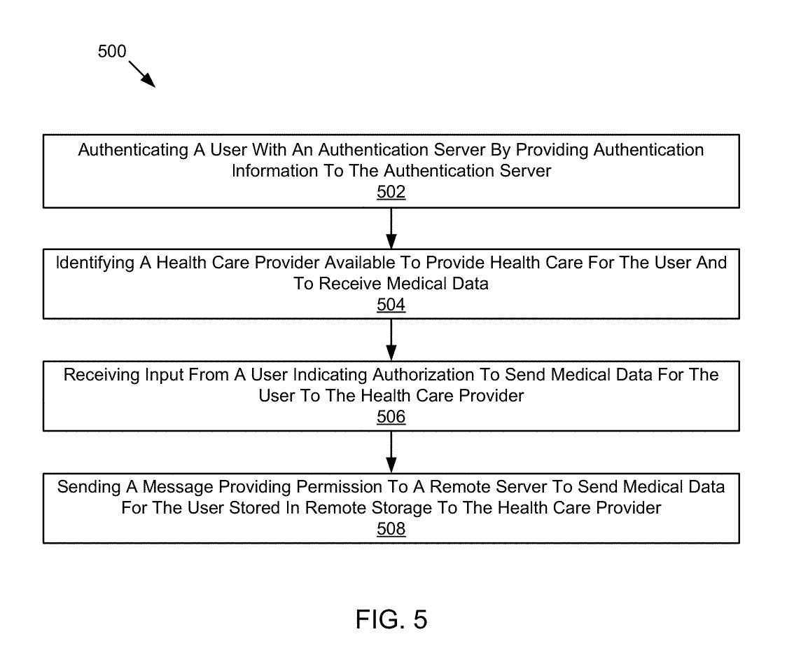

Referring now to FIG. 5, a schematic flow chart diagram of a method 500 for communicating or approving communication of medical data to a health care provider is illustrated. The method 500 may be performed by a client device such as the client 102 of FIG. 1, 3, or 4.

The method 500 begins and an authentication component 302 authenticates 502 a user with an authentication server (such as a remote medical data system 104) by providing authentication information to the authentication server. A destination component 304 identifies 504 a health care provider available to provide health care for the user and to receive medical data. A permission component 306 receives 506 input from the user indicating authorization to send medical data to the health care provider. A message component 308 sends 508 a message providing permission to a remote server (such as a medical data system 104) to send medical data for the user stored in remote storage to the health care provider.

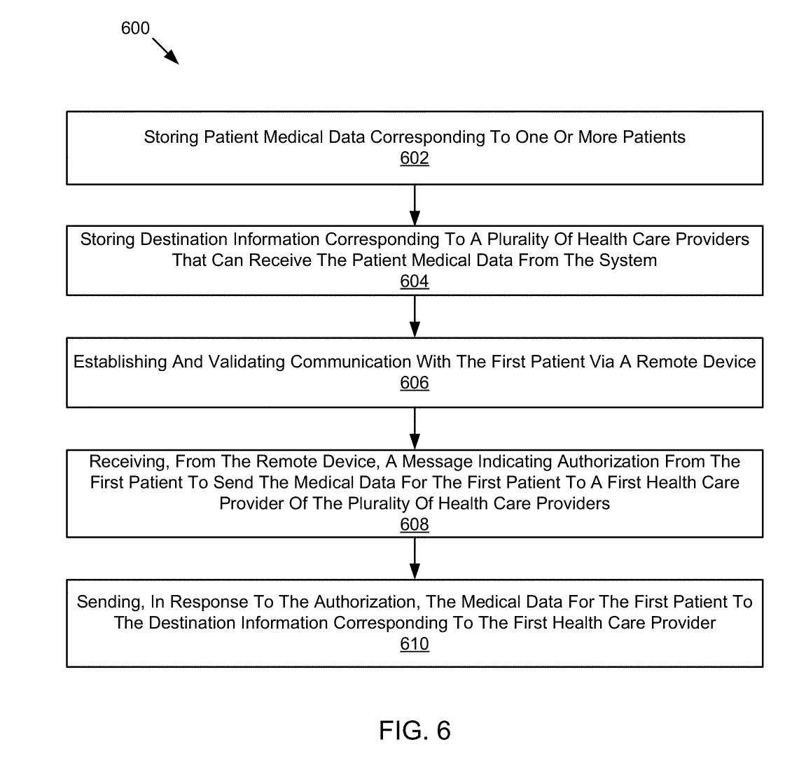

Referring now to FIG. 6, a schematic flow chart diagram of a method 600 for communicating medical data is illustrated. The method 600 may be performed by a medical data component, such as the medical data system 104 of FIG. 1, 2 or 4.

The method 600 begins and a patient data component 202 stores 602 patient medical data corresponding to one or more patients. The patient medical data may include data for a first patient. A provider component 204 is configured to store 604 destination information corresponding to a plurality of health care providers that can receive the patient medical data from the system. A session component 206 establishes and validates 606 communication with the first patient via a remote device. An authorization component 210 receives 608, from the remote device, a message indicating authorization from the first patient to send the medical data for the first patient to a first health care provider of the plurality of health care providers. A communication component 212 sends 610, in response to the authorization, the medical data for the first patient to the destination information corresponding to the first health care provider.

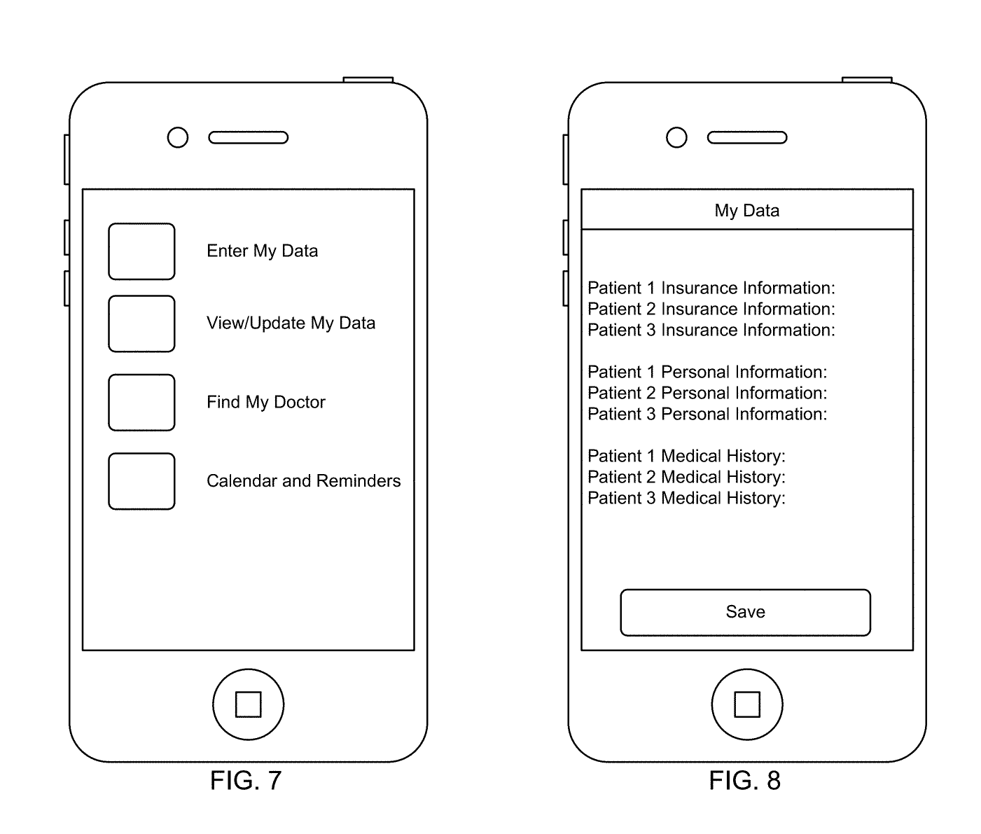

Turning now to FIGS. 7-14, example interfaces for a client smartphone are illustrated. For example, a smartphone application may provide the interfaces illustrated in the FIGS. 7-14 on a client during the methods, procedures, or operations discussed herein. Although FIGS. 7-14 are illustrated and discussed in relation to a smartphone application, similar interfaces or principles may be used for feature phone, tablet, desktop, or other applications.

FIG. 7 illustrates an example screenshot of a home screen of a smartphone application, according to one embodiment. The home screen provides an interface with different options selectable by a user. Specifically, the home screen includes an “Enter My Data” option that may be selected to bring up an interface to enter medical data (e.g., see FIG. 8). The home screen also includes a “View/Update My Data” option that may be used to view or edit existing data or data that has already been entered (e.g., see FIG. 9). The home screen includes a “Find My Doctor” option that may be used to search or browse available doctors that can receive medical information from a remote server system, such as the medical data system 104 (see FIGS. 10-11). The home screen further includes a “Calendar and Reminders” option where a user can enter information about scheduled appointments with health care providers and set up reminders for the appointments and/or reminders to send medical data to corresponding health care providers (see FIG. 14).

FIG. 8 illustrates an example screenshot of a “My Data” screen of a smartphone application, according to one embodiment. For example, the “My Data” screen may be displayed in response to a user selecting the “Enter My Data” option from the home screen of FIG. 7. The “My Data” screen includes a region where a user can enter data for one or more individuals. For example, a user may be able to enter insurance information of one or more family members. The user may also be able to enter personal information such as name, address, or other information for each family member. Medical history may also be entered to include details about allergies, family history, or any other information about a medical history of one or more family members. In one embodiment, the “My Data” screen may include a questionnaire with check boxes, text fields, or the like to that a user can enter the medical data in an organized way. For example, the “My Data” screen may be arranged to allow a user to answer any questions or other information that is generally required when a user is admitted or registered with a health care provider for treatment. Upon entry of the data, the user may select a “Save” button to save the data to a remote storage location, such as a storage managed by a medical data component 104.

FIG. 9 illustrates an example screenshot of a “View/Update My Data” screen of a smartphone application, according to one embodiment. For example, the “View/Update My Data” screen may be displayed in response to a user selecting the “View/Update My Data” option from the home screen of FIG. 7. The smartphone application may download data stored in a remote server for display to a user in the “View/Update My Data” screen. The “View/Update My Data” screen allows a user to view and/or edit existing medical data that is stored in remote storage. For example, the user may be able tap or click in a text field to edit, add, delete, or otherwise modify data. Upon editing or completion of editing, the user may select a “Save” button to save the modified data to the remote storage.

FIG. 10 illustrates an example screenshot of a “Find My Doctor” screen of a smartphone application, according to one embodiment. For example, the “Find My Doctor” screen may be displayed in response to a user selecting the “Find My Doctor” option from the home screen of FIG. 7. The “Find My Doctor” screen displays fields for a user to enter information to search for a health care provider, such as a doctor who is able to receive medical data from a medical data system 104. The user may enter information regarding a name, city state, zip code, specialty or other details. After entering any search criteria, the user may select a “Search” button to submit a query.

FIG. 11 illustrates an example screenshot of a “Search Results” screen of a smartphone application, according to one embodiment. For example, the “Search Results” screen may be displayed in response to a user selecting the “Search” button from the “Find My Doctor” screen of FIG. 10. The “Search Results” screen displays a plurality of search results. Specific to the screen in FIG. 11, the “Search Results” screen illustrates the results of a search based on a zip code. The user may be able to browse (e.g., scroll) through the list of providers in the zip code. If the user selects a “Search” button, the user may return to the “Find My Doctor” interface of FIG. 10. If the user selects a search result, the user may be taken to a screen where the details of the search result can be viewed.

FIG. 12 illustrates an example screenshot of a “Send Data” screen of a smartphone application, according to one embodiment. For example, the “Send Data” screen may be displayed in response to a user selecting a search result from the “Search Results” screen of FIG. 11. The “Send Data” screen shows a selected health care provider and asks a user whether they would like to send medical data to the selected health care provider. If the user wants to send data to the health care provider, the user may select at “Send” button to send the data. If the user does not want to send the data the user may select a “Cancel” button to return to the search results.

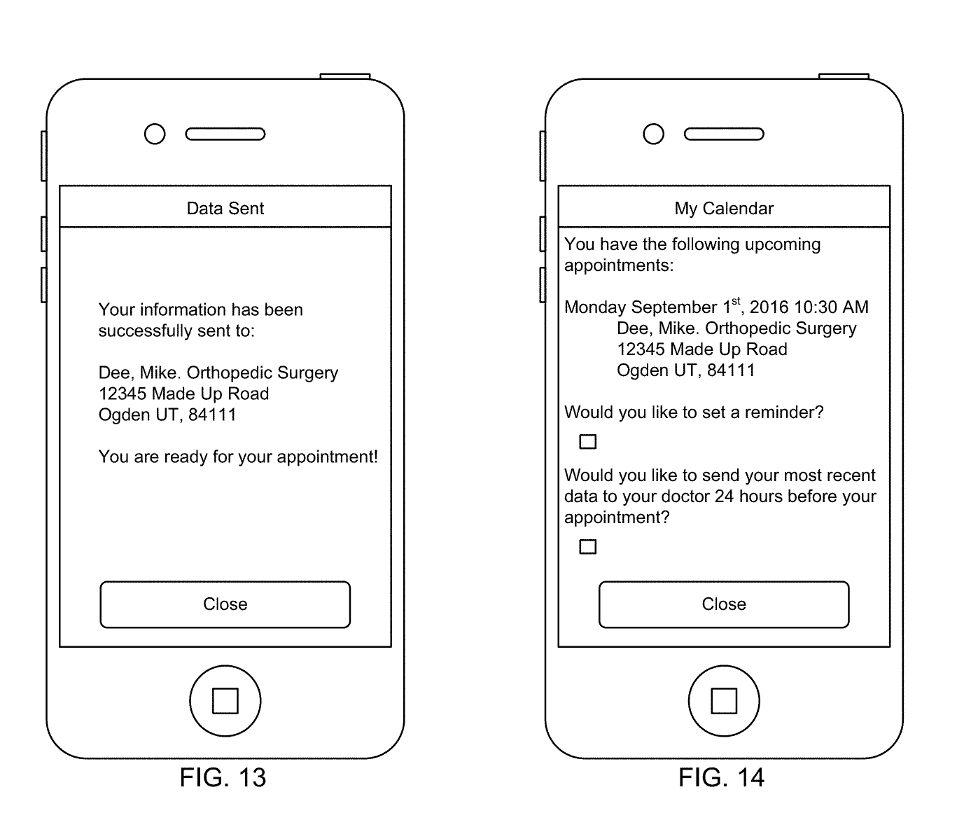

FIG. 13 illustrates an example screenshot of a “Data Sent” screen of a smartphone application, according to one embodiment. For example, the “Data Sent” screen may be displayed in response to a user selecting a “Send” button from the screen of FIG. 12. The “Data Sent” may provide confirmation that a user's medical data has been sent to a doctor in advance of an appointment. The user may then know what they are ready for their appointment.

FIG. 14 illustrates an example screenshot of a “My Calendar” screen of a smartphone application, according to one embodiment. For example, the “My Calendar” screen may be displayed in response to a user selecting a “Calendar and Reminders” option button from the home screen of FIG. 7. The “My Calendar” screen may present information about upcoming appointments or other scheduled doctor's visits. The “My Calendar” screen presents information about an upcoming appointment. The “My Calendar” screen also provides an option to set a reminder about the appointment. For example, the smartphone application may provide a notification in the form of a smartphone notification, email, call, or other notification in advance of the appointment to remind the user that the appointment is scheduled. The “My Calendar” provides an option to send data to doctor in advance of the scheduled appointment. For example, the user may select an option to have the most recent data sent to the scheduled health care provider 24 hours before the appointment, if the appointment has not been cancelled.

### Examples

The following examples pertain to further embodiments.

Example 1 is a method for communicating medical data. The method includes authenticating a user with an authentication server by providing authentication information to the authentication server. The method includes identifying a health care provider available to provide health care for the use. The method includes, in response to authenticating the user, receiving input from a user indicating authorization to send medical records to the health care provider. The method includes sending a message providing permission to a remote server to send medical data for the user stored in remote storage to the health care provider.

In Example 2, the method of Example 1 further includes receiving the medical data for the user from the remote storage and providing the medical data for the user on a display for viewing by the user.

In Example 3, the method of any of Examples 1-2 further includes receiving input from the user indicating modifications to the medical data for the user and sending messages to the remote storage to modify the medical data for the user based in the input from the user.

In Example 4, the method of any of Example 1-3 further comprising deleting the medical data for the user from local memory in response to disconnecting from the authentication server.

In Example 5, the medical data in any of Examples 1-4 is received and stored in local storage in an encrypted state.

In Example 6, the message in any of Examples 1-5 provides permission to provide the medical data for the user in advance of a scheduled appointment with the health care provider.

In Example 7, the method of any of Examples 1-6 further includes: receiving a provider query from a user; providing the provider query to a remote server; and receiving search results indicating one or more providers that are configured to receive the medical data for the user from the remote storage.

In Example 8, the method of any of Examples 1-7 further includes prompting the user to update or review medical data stored in the remote storage.

Example 9 is a computer readable medium storing instructions that cause one or more processors to perform a method as in any of Examples 1-8.

Example 10 is a system or device that includes means for implementing a method or realizing a system or apparatus as in any of Examples 1-9.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A mobile computing device comprising:
an authentication component configured to authenticate a user with an authentication server by providing authentication information to the authentication server;
a destination component configured to identify a health care provider available to provide health care for the user and to receive medical data;
a permission component configured to, in response to authenticating the user, receive input from a user indicating authorization to send medical data for the first patient to the health care provider; and
a message component configured to send a message providing permission to a remote server to send medical data for the user stored in remote storage to the health care provider.

2. The mobile computing device of claim 1, further comprising a review component configured to receive the medical data for the user from the remote storage and provide the medical data for the user on a display for viewing by the user.

3. The mobile computing device of claim 2, further comprising an edit component configured to:
receive input from the user indicating modifications to the medical data for the user; and
send messages to the remote storage to modify the medical data for the user based on the input from the user.

4. The mobile computing device of claim 2, further comprising a security component configured to delete the medical data for the user from local memory in response to disconnecting from the authentication server.

5. The mobile computing device of claim 2, wherein the review component is configured to one or more of receive medical data for the first user and store the medical data for the first user in local storage in an encrypted state.

6. The mobile computing device of claim 1, wherein the destination component is further configured to:
receive a provider query from a user;
provide the provider query to a remote server; and
receive search results indicating one or more providers that are configured to receive the medical data for the user from the remote storage.

7. The mobile computing device of claim 1, wherein the message provides permission to the remote server to provide the medical data for the user in advance of a scheduled appointment with the health care provider.

8. The mobile computing device of claim 1, further comprising a prompt component configured to prompt the user to update or review medical data stored in the remote storage.

9. A method comprising:
authenticating a user with an authentication server by providing authentication information to the authentication server;
identifying a health care provider available to provide health care for the user;
in response to authenticating the user, receiving input from a user indicating authorization to send medical records to the health care provider; and
sending a message providing permission to a remote server to send medical data for the user stored in remote storage to the health care provider.

10. The method of claim 9, further comprising receiving the medical data for the user from the remote storage and providing the medical data for the user on a display for viewing by the user.

11. The method of claim 10, further comprising:
receiving input from the user indicating modifications to the medical data for the user; and
sending messages to the remote storage to modify the medical data for the user based in the input from the user.

12. The method of claim 10, further comprising deleting the medical data for the user from local memory in response to disconnecting from the authentication server.

13. The method of claim 9, wherein the medical data is received and stored in local storage in an encrypted state.

14. The method of claim 9, wherein the message provides permission to provide the medical data for the user in advance of a scheduled appointment with the health care provider.

15. Computer readable storage media storing instructions that, when executed by one or more processors, cause the processors to:
authenticate a user with an authentication server by providing authentication information to the authentication server;
identify a health care provider available to provide health care for the user;
in response to authenticating the user, receiving input from a user indicating authorization to send medical records to the health care provider; and
send a message providing permission to a remote server to send medical data for the user stored in remote storage to the health care provider.

16. The computer readable storage media of claim 15, further storing instructions that cause the processors to receive the medical data for the user from the remote storage and provide the medical data for the user on a display for viewing by the user.

17. The computer readable storage media of claim 16, further storing instructions that cause the processors to delete the medical data for the user from local memory in response to disconnecting from the authentication server.

18. The computer readable storage media of claim 15, further storing instructions that cause the processors to:
receive a provider query from a user;
provide the provider query to a remote server; and
receive search results indicating one or more providers that are configured to receive the medical data for the user from the remote storage.

19. The computer readable storage media of claim 15, wherein the message provides permission to provide the medical data for the uses in advance of a scheduled appointment with the health care provider.

20. The computer readable storage media of claim 15, further storing instructions that cause the processors to prompt the user to update or review data medical data stored in the remote storage.
